(19) United States
(12) Patent Application Publication
(10) Pub. No.: US 2010/0159128 A1
(43) Pub. Date: Jun. 24, 2010

(54) Niobium 2-ethylhexanoate derivative, method of producing the derivative, organic acid metal salt composition containing the derivative, and method of producing thin film using the composition

(76) Inventors: Atsuya Yoshinaka, Tokyo (JP); Hiroyuki Kameda, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/654,841

(22) Filed: Jan. 6, 2010

Related U.S. Application Data
(62) Division of application No. 11/921,575, filed on Dec. 5, 2007.

(30) Foreign Application Priority Data
Jun. 10, 2005 (JP) 2005-171441
Jun. 10, 2005 (JP) 2005-171444

(51) Int. Cl. B05D 5/12

(52) U.S. Cl. 427/126.1

(57) ABSTRACT

The present invention provides a niobium 2-ethylhexanoate derivative having a niobium content of from 13 to 16 mass % and a carbon content within a range of from 50 to 58 mass %, the niobium 2-ethylhexanoate derivative consisting only of: niobium atoms, oxygen atoms, and 2-ethylhexanoic acid residues; the niobium 2-ethylhexanoate derivative can be produced by reacting pentakis(alkoxy)niobium with 2-ethylhexanoic acid; further, the organic acid metal salt composition of the present invention includes the niobium 2-ethylhexanoate derivative, a metal precursor other than niobium, and at least one kind of an organic solvent; and the thin film including a niobium element and metal other than niobium can be formed on a substrate by applying the organic acid metal salt composition on the substrate and heating the substrate with the applied organic acid metal salt composition.

This is a divisional Ser. No. 11/921,575, which is the National Stage of International Application No. PCT/JP2006/310737, filed May 30, 2006.

### TECHNICAL FIELD

The present invention relates to a niobium 2-ethylhexanoate derivative with a specific structure, a method of producing the derivative, an organic acid metal salt composition containing the niobium 2-ethylhexanoate derivative, a metal precursor other than niobium and an organic solvent, and a method of producing a thin film using the composition.

### RELATED ART

A ceramic thin film containing a niobium element or a ceramic thin film containing a niobium element and a lead element has specific electrical properties, and the applications thereof to various uses have been examined. In particular, the ceramic thin films are used for electronic units of electronic components, such as high dielectric capacitors, ferroelectric capacitors, gate dielectric films, barrier films, and piezoelectric elements, which apply properties of the excellent dielectric characteristics. For example, Non-patent Document 1 reports a niobium-doped lead-zirconium-titanate (PNZT) thin film in which a titanium site of lead-zirconium-titanate is partially substituted with niobium.

Mentioned as methods of producing the above thin film are: Metal Organic Deposition (MOD) methods such as coating pyrolysis methods and sol gel methods; Chemical Vapor Deposition (CVD) methods; Atomic Layer Deposition (ALD) methods; and the like. For a thin film with relatively low processing accuracy, the MOD methods which save manufacturing costs and facilitate the formation of thin films are suitable. For thin film precursors for use in the MOD methods, alkoside compounds and organic acid metal salts are mainly used, and the same also applies to niobium precursors.

Patent Document 1 discloses a composition for forming a Bi-based ferroelectric thin film obtained by mixing a metal compound in an organic solvent in such a manner that a metal composition ratio (molar ratio) in the solution is represented by A:B:C═X:Y:Z (where A represents Sr and Ba and/or Pb, B represents Bi, C represents Ta and/or Nb, 0.4≦X≦1.0, 1.5≦Y≦3.5, and Z=2) and, when the ratio is represented by Sr:Ba:Pb=a:b:c (where 0.7≦X≦a≦X and 0<b+c≦0.3X) (claim 1). In paragraph [0024] of Patent Document 1, mentioned as a niobium compound are: alkoxides such as niobium ethoxide, niobium propoxide, niobium butoxide, and niobium-2-methoxy ethoxide; carboxylic acids such as niobium octylate, niobium n-hexanoate, niobium 2-ethylbutyrate, and niobium i-valerate; and the like, and mentioned as a lead compound are: carboxylates such as lead octylate, lead n-hexanoate, lead 2-ethyl butyrate, lead i-valerate, and lead acetate; alkoxides such as lead ethoxide, lead propoxide, and lead butoxide; and the like.

Patent Document 2 discloses: a Bi-based ferroelectric thin film containing a foundation layer having a thickness of 5 to 50 nm whose composition is represented by Bi₂(TaₘNb₁₋ₘ)₂O₈ (where 0≦m≦1) and a main layer formed on the foundation layer whose composition is represented by (Sr_{X}Bi_{1-X})Bi₂(Ta_{Y}Nb_{1-Y})₂O_{Z} (where 0.4≦X≦1, 0≦Y≦1, and Z is a total number of oxygen atoms attached to each metal element) (claim 1); and a Bi-based ferroelectric thin film having a thickness of 5 to 50 nm whose composition is represented by Bi₂(TaₘNb₁₋ₘ)₂O₈ (where 0≦m≦1) and a main layer formed on the foundation layer whose composition is represented by [{Sr_{X}(Pb and/or Baₙ}_{X}Bi_{1-X}]Bi₂(Ta_{Y}Nb_{1-Y})₂O_{Z}] (where 0<n≦0.3, 0.4≦X≦1, 0≦Y≦1, and Z is the total of oxygen atoms attached to each metal element) (claim 2). In paragraph [0025] of Patent Document 2, mentioned as a niobium compound are: alkoxides such as niobium ethoxide, niobium propoxide, niobium butoxide, and niobium-2-methoxy ethoxide; carboxylates such as niobium octylate, niobium n-hexanoate, niobium 2-ethylbutyrate, and niobium i-valerate; and the like and mentioned as a lead compound are: carboxylates such as lead octylate, lead n-hexanoate, lead 2-ethyl butyrate, lead i-valerate, and lead acetate; alkoxides such as lead ethoxide, lead propoxide, and lead butoxide; and the like.

Patent Document 3 discloses a method of producing an electronic device including a step of providing a plurality of polyoxy alkylated metal moieties including perovskite A-site moieties, perovskite B-site moieties, and superlattice-generator moieties. More particularly, the method is a step of combining each metal moiety in a relative proportion corresponding to a laminated superlattice material (112) in which a plurality of layers (116, 124, 128) are disposed in order. The order is: an A/B layer (124) formed from a metal oxide selected from the group consisting of an A-site metal, a B-site metal, and a mixture thereof and having an A/B ionic subunit cell (146); a superlattice-generator layer (116) having a superlattice-generator ionic subunit cell; and a perovskite AB layer (128) containing both the A-site metal and the B-site metal. The method includes the steps of: containing a perovskite AB layer which has a perovskite oxygen octahedral lattice different from the lattice of the A/B layer; applying the precursor solution to a substrate; and treating the precursor solution on the substrate, thereby forming a mixed laminated lattice material having the A/B layer, the superlattice-generator layer, and the perovskite AB layer. Patent Document 3 discloses in Example 4 on page 47 the use of niobium 2-ethylhexanoate as a raw material for a pre-precursor solution.

Patent Document 1: JP 09-25124 A, Claim, [0024]

Patent Document 2: JP 09-142845 A, Claim, [0025]

Patent Document 3: JP 11-509683 A, Claim, Page 47

Non-patent Document 1: Jpn. Appl. Phys., Vol. 44, No. 1A(2005) 267-274

### DISCLOSURE OF THE INVENTION

### Problems to be solved by the Invention

The above-mentioned niobium salt of the organic acid is greatly different in characteristics and physical properties from the derivatives to be obtained, because of production processes and production conditions, and thus has problem in that it is difficult to handle as a precursor for the MOD method. One of the problems in the MOD method resides in that it is difficult to acquire sufficient stability for a coating liquid composition containing a precursor. In order to form a multicomponent ceramic thin film, a composition serving as a coating liquid forms a mixed solution of a precursor containing various metallic elements in a thin film. For example, when using a metal alkoxide compound as a precursor compound, the metal alkoxide reacts, due to high reactivity, with other precursors, moisture in the atmosphere, etc., resulting in deterioration such as in thickening/gelation and formation of precipitates. Such deterioration adversely effects the application step or membrane quality. Because the states (shapes and electrical properties) of thin films to be obtained depend on combinations of precursors, it is difficult to find an optimal combination in view of the above-mentioned stability problem. For example, it is known that alkoxide compounds provide excellent thin film as a precursor of titanium or zirconium. However, when another precursor component is mixed therewith, it is difficult to acquire a thin film with storage stability that does not deteriorate in use.

In general, the niobium salt of the organic acid is written as (RCOO)₅Nb in many cases, and has various carbon content and Nb content. In fact, the binding unit forming said niobium salt is “RCOO—Nb and Nb—O—Nb”, “RCOO—Nb and Nb═O” or “RCOO—Nb, Nb—O—Nb, and Nb═O”. For example, typical simple-structure models are as represented by the following chemical formulae, but it is difficult to exactly identify chemical structures. In the following chemical formulae, L represents an organic acid residue.

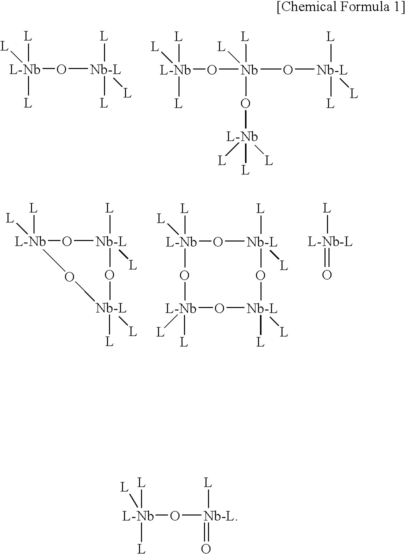

Here, for example, a niobium derivative of an organic acid having a composition of a carbon content and an Nb content which are close to the composition of (RCOO)₅Nb obtained by reacting niobium penta alkoxide with an organic acid has poor storage stability. It is known that an alkoxy group is likely to remain in the niobium derivative obtained from niobium penta alkoxide, and is actually considered to be a compound formed of RCOO—Nb, Nb—O—Nb, and Nb—OR′ (OR′ is an alkoxy group derived from the raw material). Moreover, it is also conceived that the storage stability of the compound itself which has a structure of (RCOO)₅Nb is also poor. In contrast, when the number of Nb—O—Nb chains is large, the molecular weight and the niobium content becomes large and the carbon content becomes small. Because the solubility of such niobium derivative of organic acid is deteriorated, usable solvents and the concentrations thereof are limited, i.e., the solubility margin becomes narrower. Moreover, when used in combination with another metal precursor, niobium oxide is localized in the thin film to be obtained. Thus, portions where desired uniform compositions and crystal structures are not formed increase, which makes it impossible for the thin film to be obtained to acquire the expected electrical properties.

A coating liquid employing niobium 2-ethylhexanoate which has a composition value close to the theoretical value of Nb[C₄H₅CH(C₂H₅)COO]₅, i.e., the niobium content is about 11.5 mass %, as a precursor has a problem in that the storage stability is poor. Moreover, such niobium salt of organic acid, when further mixed with another precursor compound for use, causes problems in that the coating liquid forms a gel and generates precipitates due to chemical reaction.

Therefore, an object of the present invention is to provide a niobium 2-ethylhexanoate derivative useful as a precursor for the MOD method and a production method therefor.

Moreover, another object of the present invention is to provide an organic acid metal salt composition containing a niobium precursor and a metal precursor other than niobium which are suitable as raw materials for the MOD methods when producing a thin film containing niobium and metal other than niobium by the MOD method, and a method of producing a thin film using the composition.

### Means for solving the Problems

The inventors of the present invention carried out intensive research and found that a niobium 2-ethylhexanoate derivative with a specific structure can solve the above-mentioned problems. Thus, the present invention has been accomplished.

That is, a niobium 2-ethylhexanoate derivative of the present invention has a niobium content of from 13 to 16 mass % and a carbon content of from 50 to 58 mass %, and consists only of niobium atoms, oxygen atoms, and 2-ethylhexanoic acid residues.

Further, the above niobium 2-ethylhexanoate derivative can be produced by reacting pentakis(alkoxy)niobium with 2-ethylhexanoic acid.

Still further, the present invention provides an organic acid metal salt composition, including the above niobium 2-ethylhexanoate derivative, a metal precursor other than niobium, and at least one kind of an organic solvent.

Further, the organic acid metal salt composition of the present invention may include another arbitrary metal precursor.

Still further, a method of forming a thin film on a substrate of the present invention includes: applying the above organic acid metal salt composition on the substrate; and heating the substrate applied with the organic acid metal salt composition to form the thin film including a niobium element and a metal other than niobium.

### BRIEF DESCRIPTION OF THE DRAWINGS

FIG. 1 is a ¹H-NMR analysis chart of a niobium 2-ethylhexanoate derivative of the present invention obtained in Example 1.

FIG. 2 is a ¹³C-NMR analysis chart of the niobium 2-ethylhexanoate derivative of the present invention obtained in Example 1.

FIG. 3 is an IR analysis chart of the niobium 2-ethylhexanoate derivative of the present invention obtained in Example 1.

FIG. 4 is a TG-DTA analysis chart of the niobium 2-ethylhexanoate derivative of the present invention obtained in Example 1.

### BEST MODE FOR CARRYING OUT THE INVENTION

The niobium 2-ethylhexanoate derivative of the present invention consists only of niobium atoms, oxygen atoms, and 2-ethylhexanoic acid residues, in which the niobium content is within the range of from 13 to 16 mass %, preferably 13 to 15 mass %, and the carbon content is within the range of from 50 to 58 mass %, and preferably 52 to 57 mass %. A theoretical value of composition of niobium 2-ethylhexanoate is a niobium content of 11.5 mass % and carbon content of 59.4 mass %.

A niobium content of less than 13 mass % is not preferable because storage stability is deteriorated, and niobium content exceeding 16 mass % is not preferable because the solubility margin becomes narrow. Moreover, a carbon content of less than 50 mass % is not preferable because the solubility margin becomes narrow, and a carbon content exceeding 58 mass % is not preferable because storage stability is deteriorated.

The features of the niobium 2-ethylhexanoate derivative of the present invention reside in that the niobium 2-ethylhexanoate derivative is liquid, has excellent storage stability and stability after mixing, and has a wide solubility margin. Thus, the niobium 2-ethylhexanoate derivative of the present invention is useful as a precursor for an MOD method. Selecting 2-ethylhexanoic acid as an organic acid component also contributes to the features.

For example, a niobium derivative of an organic acid with a small number of carbon atoms serving as an organic acid component such as acetic acid and valeric acid tends to solidify, and makes it difficult to provide a stable coating liquid. Moreover, because the solubility in an organic solvent is low, a solubility margin cannot be acquired. Further, it has a problem in that an unpleasant odor is produced. Because a niobium derivative of an organic acid in which the number of carbon atoms of the organic acid component is large has a low niobium content, a sufficient solubility margin cannot be acquired with respect to the solubility expressed in terms of mole fraction in some cases. Moreover, a thin film obtained using such a niobium derivative of an organic acid for a precursor has a large amount of impure carbon residue.

A method of producing the niobium 2-ethylhexanoate derivative of the present invention employs pentakis(alkoxy)niobium for a raw material as a starting material. Mentioned as methods using pentakis(alkoxy)niobium as a raw material are a method involving adding 2-ethylhexanoic acid and heating the resultant and a method using a dehydrating agent together which removes water generated as a by-product upon reaction of pentakis(alkoxy)niobium with 2-ethylhexanoic acid. The reaction ratio of pentakis(alkoxy)niobium and 2-ethylhexanoic acid is within the range of from 3 to 8 mol, preferably 4 to 6 mol of 2-ethylhexanoic acid, per mol of pentakis(alkoxy)niobium. Here, an amount of 2-ethylhexanoic acid of less than 3 mol is not preferable because an alkoxy group remains and the storage stability is deteriorated, and an amount of 2-ethylhexanoic acid exceeding 8 mol is not preferable because no effect accompanying by the increase in the addition amount is demonstrated, resulting in economic disadvantage.

Mentioned as pentakis(alkoxy)niobium used as a starting material in the production method for the niobium 2-ethylhexanoate derivative of the present invention are, for example, C₁₋₄ alkoxides such as pentakis(methoxy)niobium, pentakis(ethoxy)niobium, pentakis(propoxy)niobium, pentakis(isopropoxy)niobium, and pentakis(butoxy)niobium.

In the case of using pentakis(alkoxy)niobium as a starting material, when water is present in the reaction system, the linking of the Nb—O—Nb chain progresses, making control of the reaction difficult. Therefore, it is preferable to use a dehydrating agent which consumes water generated as a by-product in the production method for the niobium 2-ethylhexanoate derivative of the present invention. Mentioned as the above-mentioned dehydrating agents are: acid anhydrides such as acetic anhydride, maleic anhydride, citraconic acid anhydride, malonic acid anhydride, itaconic acid anhydride, phthalic acid anhydride, and succinic acid anhydride; orthoformates such as triethyl orthoformate and trimethyl orthoformate; and the like. Of those, acid anhydride is preferable and acetic anhydride is the most preferable because they are easily removed from the reaction system after the reaction. An amount of dehydrating agent is within the range of from 0.5 to 10 mol, and preferably 1 to 8 mol, per mol of pentakis(alkoxy)niobium serving as a raw material. An amount of dehydrating agent of less than 0.5 mol is not preferable because the use effect may not be developed, and an amount of dehydrating agent exceeding 10 mol is not preferable because no effect accompanying by the increase in the addition amount is demonstrated, resulting in economic disadvantage.

In the production method for the niobium 2-ethylhexanoate derivative of the present invention, the reaction temperature is within the range of from 100 to 150° C., and preferably 110 to 140° C. Here, a reaction temperature of less than 100° C. is not preferable because it takes a lot of time to complete the reaction and an alkoxy group may remain in the production product, and a reaction temperature exceeding 150° C. is not preferable because it is difficult to control the reaction and, in some cases, it is difficult to control the molecular weight and the niobium content.

Mentioned as a thin film which can be produced by the MOD method using a raw material for the MOD method employing the niobium 2-ethylhexanoate derivative of the present invention, are, for example: dielectric thin films such as niobium oxide and niobium-tantalate oxide (Ta₂₋ₓNbₓO₅); piezoelectric thin films such as lithium niobate; and ferroelectric thin films such as niobium-bismuth tantalate [Bi₂(TaₘNb₁₋ₘ)₂O₅], niobium-bismuth tantalate strontium (Sr₁₋ₓBaₓTa_{2-y}Nb_{y}O₉), niobium-doped lead titanate, niobium-doped bismuth titanate, niobium-doped lead titanate, and niobium-doped titanic acid lead zirconate.

When using the niobium 2-ethylhexanoate derivative of the present invention as a raw material for the MOD method of producing the above-mentioned thin films, the niobium 2-ethylhexanoate derivative of the present invention can be used as a composition containing an organic solvent and, if required, a precursor compound and the like which introduce another element into the thin film. The composition may take any form such as an emulsion, a suspension, a dispersion, a colloidal dispersion, and a solution. It is preferable to use the composition as a solution capable of forming a thin film whose composition uniformity is favorable and whose surface condition is excellent. The content of the niobium 2-ethylhexanoate derivative in the composition is usually within the range of from 1 to 50 mass %, and preferably within the range of from 5 to 40 mass %, where the application to a substrate is easy.

The organic acid metal salt composition of the present invention is an organic acid metal salt composition containing, as an essential ingredient, the above-mentioned niobium 2-ethylhexanoate derivative as a niobium precursor, a metal precursor other than niobium, and at least one organic solvent, and, as required, another metal precursor may be incorporated. The organic acid metal salt composition of the present invention is useful as a raw material for producing a thin film of glass or ceramic on a substrate by MOD methods such as coating pyrolysis or a sol gel methods.

Examples of the kind of the metal for the metal precursor other than niobium include: Group 1 elements in the periodic table, such as lithium, sodium, potassium, rubidium, and cesium; Group 2 elements in the periodic table, such as beryllium, magnesium, calcium, strontium, barium; Group 3 elements in the periodic table, such as scandium, yttrium, lanthanoid elements (lanthanum, cerium, praseodymium, neodymium, promethium, samarium, europium, gadolinium, terbium, dysprosium, holmium, erbium, thulium, ytterbium, and lutetium), and actinoid elements; Group 4 elements in the periodic table, such as titanium, zirconium, and hafnium; Group 5 elements in the periodic table, such as vanadium and tantalum; Group 6 elements in the periodic table, such as chrome, molybdenum, and tungsten; Group 7 elements in the periodic table, such as manganese, technetium, and rhenium; Group 8 elements in the periodic table, such as iron, ruthenium, osmium; elements of Group 9 in the periodic table, such as cobalt, rhodium, and iridium; Group 10 elements in the periodic table, such as nickel, palladium, and platinum; Group 11 elements in the periodic table, such as copper, silver, and gold; Group 12 elements in the periodic table, such as zinc, cadmium, and mercury; Group 13 elements in the periodic table, such as alminium, gallium, indium, and thallium; Group 14 elements in the periodic table, such as silicon, germanium, tin, and lead; Group 15 elements in the periodic table, such as arsenic, antimony, and bismuth; and Group 16 elements in the periodic table, such as polonium. In addition, examples of other metal precursors include organic acid metal salts, metal alkoxide compounds, β-diketone metal complexes, and β-ketoester metal complexes.

The niobium 2-ethylhexanoate derivative of the present invention is useful as a precursor for a thin film obtained by using lead together therewith. Therefore, in the organic acid metal salt composition of the present invention, a metal precursor other than niobium, which is particularly suitable for the combined use with the niobium 2-ethylhexanoate derivative, is a lead precursor, and, particularly, an organic acid lead compound.

Unlike the above-mentioned niobium 2-ethylhexanoate derivative, the above-mentioned lead salt compound of organic acid has a structure substantially represented by the formula (RCOO)₂Pb. Moreover, the lead salt compound of organic acid may contain water of crystallization. The lead salt compound of organic acid used in the present invention may be a hydrate or an anhydride, and an anhydride is preferable because when another precursor used together reacts with water, the stability after mixing and the storage stability are deteriorated in some cases.

Examples of the organic acid constituting the lead salt compound of organic acid include preferably an aliphatic organic acid having 2 to 18 carbon atoms, such as acetic acid, propionic acid, butyric acid, isobutyric acid, valeric acid, caproic acid, caplylic acid, 2-ethylhexanoate, pelargonic acid, capric acid, neodecanoic acid, undecanoic acid, lauric acid, tridecanoic acid, myristic acid, pentadecanoic acid, palmitic acid, margaric acid, stearic acid, linoleic acid, γ-linolenic acid, linolenic acid, ricinoleic acid, and 12-hydroxystearic acid.

Here, some of the lead salt compounds of organic acid obtained from aliphatic organic acid salts with a relatively small number of carbon atoms, such as acetic acid, propionic acid, and valeric acid are solid, and, in some cases, it is difficult for the solid lead salt compounds of organic acid to provide a sufficiently stable organic acid metal salt composition as a raw material for the MOD method. Moreover, because the organic acid lead compounds obtained from such aliphatic organic acids have low solubility in an organic solvent, a sufficient solubility margin cannot be obtained in some cases. In contrast, because lead salt compounds of organic acid obtained from aliphatic organic acids having a large number of carbon atoms, such as stearic acid, have a small amount of lead content, a sufficient solubility margin cannot be obtained with respect to the solubility expressed in terms of mole fraction in some cases. Moreover, a thin film obtained by using such a lead salt compound of an organic acid obtained from such aliphatic organic acid for a precursor has a large amount of impure carbon residues in many cases. Moreover, it is also necessary that stable-quality organic acids forming lead salt compounds of organic acid can be obtained at a low cost. Therefore, as the organic acids forming the lead salt compounds of organic acid, C₆₋₁₂ aliphatic organic acids are preferable, and 2-ethylhexanoic acid is more preferable.

Any lead salt compounds of organic acid obtained by applying known production methods can be used irrespective of production methods therefor. However, because lead salt compounds of organic acid that do not contain halogen impurities in a precursor are preferable, lead salt compounds of organic acid produced using lead oxide, lead acetate, or bis(alkoxy) lead as a raw material are preferable.

In the organic acid metal salt composition of the present invention, the mixing proportions of the niobium 2-ethylhexanoate derivative and the lead salt compound of organic acid are not limited, and they can be mixed to match their intended purpose. For example, when used as a precursor for thin films of dielectric substances or piezoelectric substances, lead atoms are 0.01 to 10 mol, and more preferably 0.1 to 5 mol in a metal molar ratio, per mol of niobium atoms.

Next, the organic solvents for use in the organic acid metal salt composition of the present invention will be described.

Mentioned as the organic solvents for use in the organic acid metal salt composition of the present invention are alcohol solvents, polyol solvents, ketone solvents, ester solvents, ether solvents, polyether solvents, aliphatic or alicyclic hydrocarbon solvents, aromatic hydrocarbon solvents, hydrocarbon solvents having a cyano group, other solvents, etc., and these can be used alone or as a mixture of two or more thereof.

Examples of the alcohol solvents include methanol, ethanol, propanol, isopropanol, butanol, isobutanol, 2-butanol, tertiary butanol, pentanol, isopentanol, 2-pentanol, neopentanol, tertiary pentanol, hexanol, 2-hexanol, heptanol, 2-heptanol, octanol, 2-ethylhexanol, 2-octanol, cyclopentanol, cyclohexanol, cycloheptanol, methylcyclopentanol, methylcyclohexanol, methylcycloheptanol, benzylalcohol, 2-methoxyethylalcohol, 2-butoxyethylalcohol, 2-(2-methoxyethoxy)ethanol, 2-(N,N-dimethylamino) ethanol, and 3-(N,N-dimethylamino)propanol.

Examples of the polyol solvents include ethylene glycol, propylene glycol, 1,2-butanediol, 1,3-butanediol, 1,4-butanediol, 1,5-pentadiol, neopentyl glycol, isoprene glycol(3-methyl-1,3-butanediol), 1,2-hexanediol, 1,6-hexanediol, 3-methyl-1,5-pentanediol, 1,2-octanediol, octanediol(2-ethyl-1,3-hexanediol), 2-butyl-2-ethyl-1,3-propanediol, 2,5-dimethyl-2,5-hexanediol, 1,2-cyclohexanediol, 1,4-cyclohexanediol, and 1,4-cyclohexanedimethanol.

Examples of the ketone solvents include acetone, ethylmethyl ketone, methylbutyl ketone, methylisobutyl ketone, ethylbutyl ketone, dipropyl ketone, diisobutyl ketone, methylamyl ketone, cyclohexanone, and methylcyclohexanone.

Examples of the ester solvents include methylformate, ethylformate, methyl acetate, ethyl acetate, isopropyl acetate, butyl acetate, isobutyl acetate, secondary butyl acetate, tertiary butyl acetate, amyl acetate, isoamyl acetate, tertiary amyl acetate, phenyl acetate, methyl propionate, ethyl propionate, isopropyl propionate, butyl propionate, isobutyl propionate, secondary butyl propionate, tertiaryl butyl propionate, amyl propionate, isoamyl propionate, tertiary amyl propionate, phenyl propionate, methyl lactate, ethyl lactate, methyl methoxypropionate, methyl ethoxylpropionate, ethyl methoxypropionate, ethyl ethoxypropionate, ethyleneglycol monomethylether acetate, diethyleneglycol monomethylether acetate, ethyleneglycol monoethylether acetate, ethyleneglycol monopropylether acetate, ethyleneglycol monoisopropylether acetate, ethyleneglycol monobutylether acetate, ethyleneglycol mono-secondary-butylether acetate, ethyleneglycol monosiobutylether acetate, ethyleneglycol mono-tertiary-butylether acetate, propyleneglycol monomethylether acetate, propyleneglycol monoethylether acetate, propyleneglycol monopropylether acetate, propyleneglycole monoisopropylehter acetate, propyleneglycol monobutylether acetate, propylene glycol mono-secondary-butylether acetate, propyleneglycol monoisobutylether acetate, propyleneglycol mono-tertiary-butyl ether acetate, butyleneglycol monomethylether acetate, butyleneglycol monoethylether acetate, butyleneglycol monopropylether acetate, butyleneglycol monoisopropylether acetate, butyleneglycol monobutylether acetate, butyleneglycol mono-secondary-butylether acetate, butyleneglycol monoisobutylether acetate, butyleneglycol mono-tertiary-butylether acetate, methyl acetoacetate, ethyl acetoacetate, methyl oxobutanoate, ethyl oxobutanoate, γ-lactone, and δ-lactone.

Examples of the ether solvents include tetrahydrofuran, tetrahydropyran, morphorin, ethyleneglycoldimethyl ether, diethyleneglycoldimethyl ether, triethyleneglycol dimethyl ether, dibutyl ether, diethyl ether, and dioxane.

Examples of the aliphatic or alicyclic hydrocarbon solvents include pentane, hexane, cyclohexane, methylcyclohexane, dimethylcyclohexane, ethylcyclohexane, heptane, octane, decaline, and solvent naphtha.

Examples of the aromatic hydrocarbon solvents include benzene, toluene, ethylbenzene, xylene, mesitylene, diethylbenzene, cumene, isobutylbenzene, cymene, and tetraline.

Examples of the solvent of hydrocarbon having a cyano group include 1-cyanopropane, 1-cyanobutane, 1-cyanohexane, cyanocyclohexane, cyanobenzene, 1,3-dicyanopropane, 1,4-dicyanobutane, 1,6-dicyanohexane, 1,4-dicyanocyclohexane, and 1,4-dicyanobenzene.

Examples of other organic solvents include N-methyl-2-pyrrolidone, dimethylsulfoxide, and dimethylformamide.

There is no limitation on the contents of the organic solvent in the organic acid metal salt composition of the present invention, and the organic solvent can be mixed to match the intended purpose. When using the organic acid metal salt composition of the present invention as a raw material for the MOD method, the organic acid metal salt composition within the range of from 20 to 99 mass % is used, and excellent coating properties can be provided within the range of from 40 to 95 mass %.

Organic solvents which exhibit sufficient solubility in a precursor and which can be easily used as a coating solvent may be selected from the above. Among the above-mentioned organic solvents, the alcohol solvents show excellent coating properties as a coating solvent to various substrates such as silicon substrates, metal substrates, ceramic substrates, glass substrates, and resin substrates, and thus are preferable, with butanol being more preferable. Moreover, even when using mixed solvents, the mixed solvents containing butanol as a main ingredient are preferable, and mixed solvents containing butanol in a proportion of 50 mass % or more are more preferable.

Moreover, the organic acid metal salt composition of the present invention can further contain any metal precursor(s) mentioned above in addition to the niobium 2-ethylhexanoate derivative and metal precursors other than niobium, preferably, a lead salt compound of an organic acid.

Titanium, zirconium, lanthanoids, bismuth, and tantalum are particularly useful as another metal precursor used in addition to the niobium 2-ethylhexanoate derivative and metal precursors other than niobium such as a lead salt compound of an organic acid, which are contained in the organic acid metal salt composition of the present invention.

Mentioned as the precursor of titanium, zirconium, or hafnium mentioned above are: tetrakis alkoxide derived from alcohol compounds, such as methanol, ethanol, propanol, 2-propanol, butanol, 2-butanol, isobutanol, tertiary butanol, amyl alcohol, isoamyl alcohol, tertiaryamyl alcohol, 2-methoxyethanol, 2-butoxyethanol, and 2-(dimethylamino)ethanol; and the organic acid metal salt derived from C₂₋₁₈ aliphatic organic acids mentioned in the description of the organic acid niobium derivative. Mentioned as the precursor of lanthanoids or bismuth are trisalkoxide derived from the above-mentioned alcohol compounds and the organic acid metal salt derived from C₂₋₁₈ aliphatic organic acids mentioned in the description of the organic acid lead compound. Mentioned as the precursor of tantalum are pentakis alkoxide derived from the above-mentioned alcohol compound and the organic acid metal salt derived from C₂₋₁₈ aliphatic organic acids mentioned in the description of the organic acid lead compound.

The organic acid metal salt composition of the present invention can provide a stable organic acid metal salt composition which is less likely to cause precipitation or gelation even when unstable metal alkoxide compounds such as tetrakis(alkoxy)titanium and tetrakis(alkoxy)zirconium are used as another metal precursor.

Next, the method of producing a thin film of the present invention will be described.

The method of producing a thin film of the present invention is obtained by the MOD method employing the organic acid metal salt composition described above as a raw material. There is no limitation on the conditions of the MOD method, and known procedures can be applied. For example, a typical procedure includes an application step of applying the organic acid metal salt composition of the present invention on a substrate and a heating/sintering step of sintering by heating the substrate or the whole to form a thin film. Between the application step and the heating/sintering step, a drying step of drying a solvent in the applied composition, and/or a calcination step of calcinating by heating at temperatures lower than that of the sintering step can be performed as required, and an annealing step may be performed after the sintering step. In order to obtain a required film thickness, the steps from the above-mentioned application step to an arbitrary step may be repeated two or more times. For example, all the steps from the application step to the sintering step may be repeated two or more times, or the application step, the drying step, and/or the calcination process may be repeated two or more times.

Mentioned as application methods in the above-mentioned application step are spin coating methods, dipping methods, spray coating methods, mist coating methods, flow coating methods, curtain coating methods, roll coating methods, knife coating methods, bar coating methods, screen printing methods, ink jet methods, brush coatings, etc.

The temperature in the above-mentioned drying step is preferably 50° C. to 200° C., and more preferably 80° C. to 150° C. The temperature in the calcination step is preferably 150° C. to 600° C., and more preferably 200° C. to 400° C. The temperature in the sintering step is preferably 400° C. to 1,000° C., and more preferably 450° C. to 800° C. The temperature in the annealing step is preferably 450° C. to 1,200° C., and more preferably 600° C. to 1,000° C.

The above-mentioned calcination step and the sintering step may be performed in various gas atmospheres for the purpose of promoting the formation of thin films and improving the surface conditions and electrical properties of the thin films. Examples of the gas include oxygen, ozone, water, carbon dioxide, hydrogen peroxide, nitrogen, helium, hydrogen, and argon.

The present invention has an effect of providing a niobium 2-ethylhexanoate derivative suitable as a precursor for the MOD method, the derivative having excellent solubility in an organic solvent and providing a stable solution when mixed with other precursors.

Moreover, the present invention can provide, as a raw material for the MOD method, an organic acid metal salt composition containing niobium and metals other than niobium, preferably a lead precursor, which has excellent storage stability. Further, according to the production method for a thin film according to the MOD method employing the composition as a raw material, a uniform thin film can be obtained.

The organic acid metal salt composition of the present invention using the 2-ethylhexanoic acid derivative of the present invention can be suitably used as a precursor for producing a thin film by the MOD method. For example, the organic acid metal salt composition of the present invention can be used in order to form a thin film of, for example, lead niobate, niobium-doped lead titanate, niobium-doped lead titanate, niobium-doped lead titanate-zirconate, bismuth-strontium-lead niobate-tantalate, and bismuth-strontium-barium-lead niobate-tantalate. Such thin films can be suitably used as dielectric elements, ferroelectric elements, piezoelectric elements, etc.

### EXAMPLES

The present invention will be described in more detail with reference to Examples and Comparative Examples described below. It should be noted that the present invention is not limited by the following Examples and the like.

### Example 1

### Production of Niobium 2-Ethylhexanoate Derivative No. 1

0.5 mol of pentakis(ethoxy)niobium and 200 ml of dry toluene were placed in a reaction flask in a dry argon gas atmosphere, and then 2.6 mol of acetic anhydride and 2.6 mol of 2-ethylhexanoic acid were added. The resultant was refluxed at a bath temperature of 120° C. for 4 hours, and then toluene and low boiling point substances were distilled off from the reaction system at a bath temperature of 135° C. Further, the pressure inside the system was reduced to 3 to 1 torr for condensation, to thereby obtain 345 g of yellow viscous liquid. The obtained yellow viscous liquid was subjected to the following determinations.

(1) Elemental Analysis

63% nitric acid water in an amount 45 times the sample mass was added and the resultant was heated to 100° C., and when the obtained powder was measured as Nb₂O₅, the niobium content was 13.7 mass %.

When the carbon content and the hydrogen content were determined by CHN elemental analysis, the C content was 55.1 mass % and the H content was 8.3 mass %.

(2) Spectrum Analysis

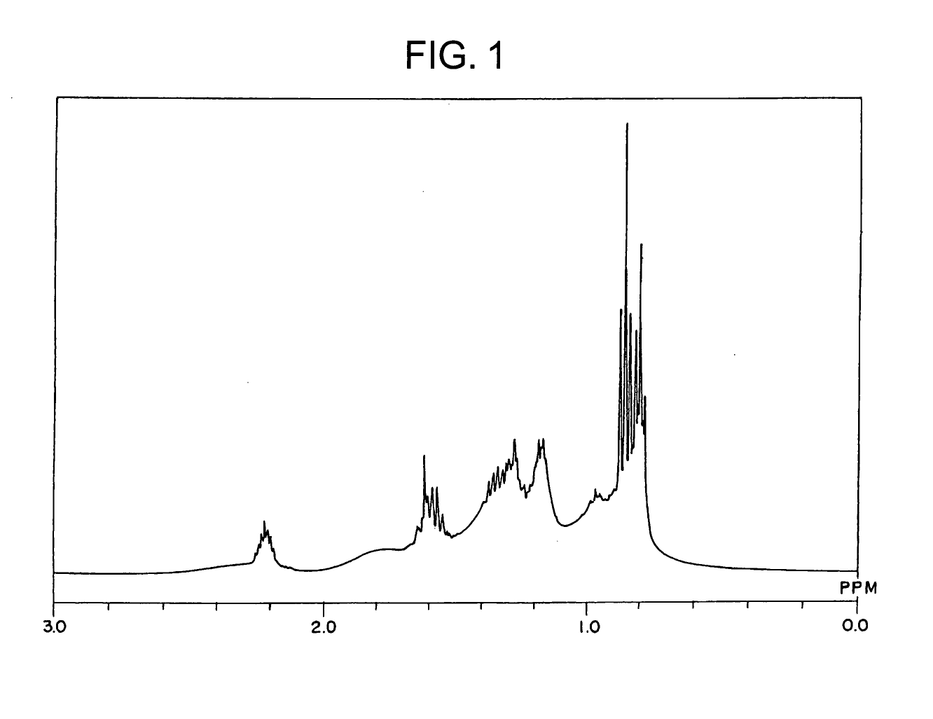

¹H-NMR analysis: The obtained chart is shown in FIG. 1. From the ¹H-NMR analysis chart shown in FIG. 1, it was confirmed that no alkoxy group was present.

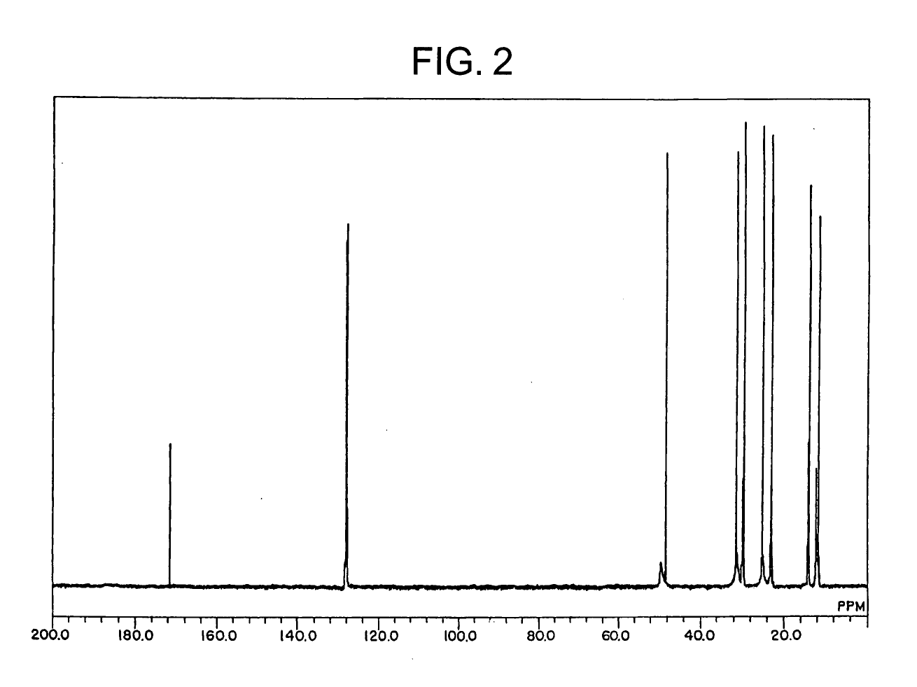

¹³C-NMR (solvent: heavy benzene): The obtained chart is shown in FIG. 2. From the chart shown in FIG. 2, it was confirmed that no alkoxy group was present. Moreover, it was confirmed that a plurality of carbon peaks of 2-ethylhexanoic acid residue were individually observed. This shows that 2-ethylhexanoic acid residues of a plurality of environments were present.

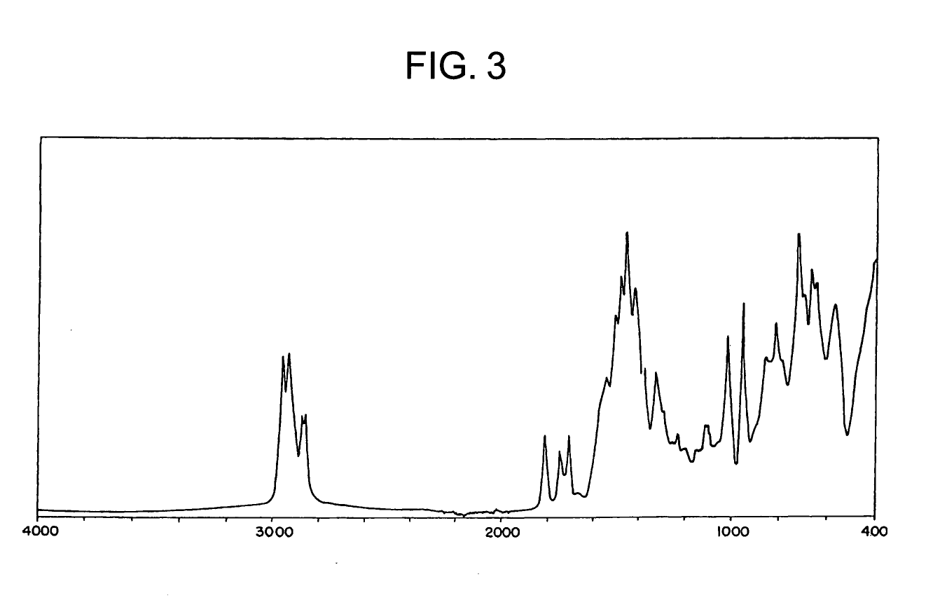

IR (coating method): The obtained chart is shown in FIG. 3. from the chart shown in FIG. 3, a plurality of absorptions were observed within the range of from 1500 to 1600 cm⁻¹ and a plurality of absorptions were also observed within the range of from 1400 to 1500 cm⁻¹. This shows that a plurality of kinds of COONb were present.

(3) Thermal Analysis

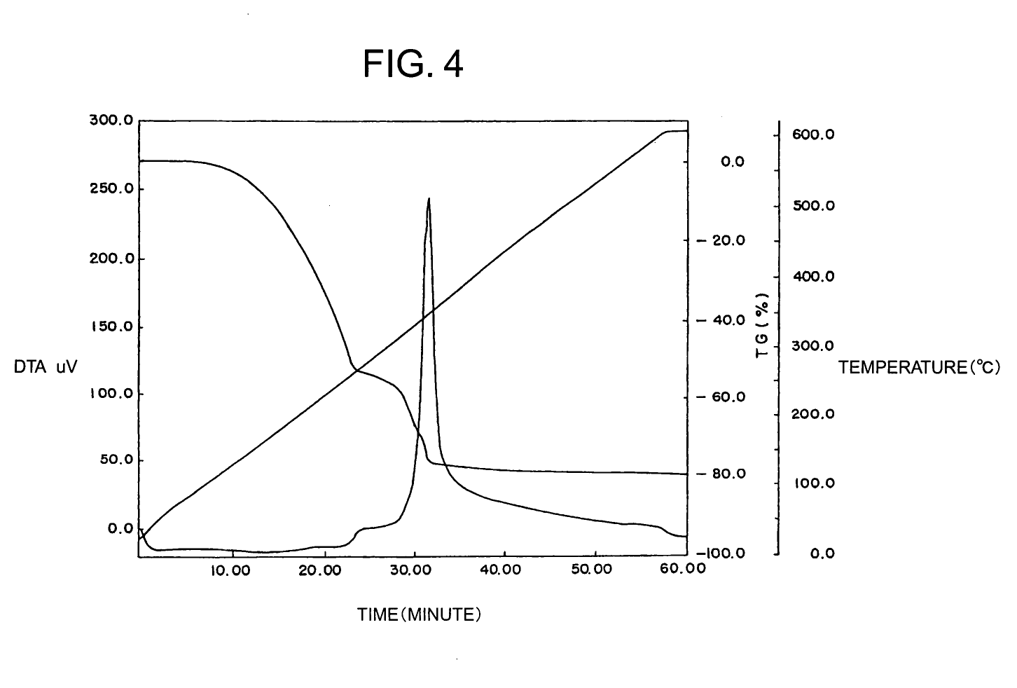

TG-DTA (Air: 300 ml/minute, Temperature elevation rate: 10° C./minute, Sample amount: 38.8037 mg, Reference alumina: 7.1320 mg): The obtained chart is shown in FIG. 4.

### Comparative Example 1

### Production of Niobium 2-Ethylhexanoate Derivative No. 2

0.5 mol of niobium pentachloride and 200 ml of ethanol were placed in a reaction flask in a dry argon gas atmosphere, 2.6 mol of 2-ethylhexanoic acid was added, and the mixture was stirred for 2 hours while blowing ammonia gas thereinto. After the blowing of ammonia gas was stopped, a reflux at a bath temperature of 80° C. was carried out for 4 hours. Then, argon gas was blown thereinto, followed by further reflux for 1 hour. The reaction liquid was cooled to room temperature, and ammonium chloride was removed by decantation and filtration. In the resultant solution, as the solvent, ethanol was replaced by toluene, and then the precipitated ammonium chloride was filtered off. Toluene and low boiling point substances were distilled off from the solution at a bath temperature of 135° C. Then, the pressure inside the system was reduced to 3 to 1 torr for condensation, thereby yielding 345 g of yellow viscous liquid. When the obtained yellow viscous liquid was subjected to the elemental analysis in the same manner as in the above-mentioned Example 1, the niobium content was 12.2 mass % and the carbon content was 59.0 mass %.

### Comparative Example 2

### Niobium 2-Ethylhexanoate Derivative No. 3

0.5 mol of pentakis(ethoxy)niobium and 200 ml of dry xylene were placed in a reaction flask in a dry argon gas atmosphere, and then 2.6 mol of 2-ethylhexanoic acid was added. The resultant was refluxed at a bath temperature of 145° C. for 4 hours, and then xylene and low boiling point substances were distilled off from the reaction system at a bath temperature of 145° C. Further, the pressure inside the system was reduced to 3 to 1 torr for condensation, thereby obtaining 335 g of yellow viscous liquid. When the obtained yellow viscous liquid was subjected to the elemental analysis in the same manner as in Example 1, the niobium content was 17.4 mass % and the carbon content was 53.0 mass %.

Evaluation 1

The niobium 2-ethylhexanoate derivatives No. 1 to No. 3 obtained in Example 1, Comparative Example 1, and Comparative Example 2 above were evaluated using toluene and butanol for the solubility in an organic solvent. The results obtained by mixing 6 g of organic solvent and 4 g of niobium 2-ethylhexanoate derivative are shown in Table 1.

TABLE 1

| | Niobium | Niobium | Niobium |
|---|---|---|---|
| | 2-ethylhexanoate | 2-ethylhexanoate | 2-ethylhexanoate |
| | derivative No. 1 | derivative No. 2 | derivative No. 3 |
| Toluene | Dissolved | Dissolved | Insoluble, Separated |
| Butanol | Dissolved | Dissolved | Insoluble, |
| | | | Separated, Cloudy |

Evaluation 2

The niobium 2-ethylhexanoate derivatives No. 1 and No. 2 obtained in Example 1 and Comparative Example 1 above were evaluated for stability after mixing using a tetrahydrofuran solution of 0.6 mol/l of pentakis(ethoxy)tantalum. 10 ml of a solution in which a niobium 2-ethylhexanoate derivative was added to a tantalum alkoxide solution in an amount with which the number of moles of niobium becomes 50% with respect to tantalum or 10 ml of a solution which does not contain a niobium 2-ethylhexanoate derivative in a tantalum alkoxide solution was placed in a 20-ml sample bottle. Then, the sample was kept in a thermo-hygrostat chamber having a temperature of 30° C. and a humidity of 50% for 18 hours, and then the sample conditions were observed. The results are shown in Table 2.

TABLE 2

| | Niobium | Niobium | |
|---|---|---|---|
| | 2-ethylhexanoate | 2-ethylhexanoate | No niobium |
| | derivative No. 1 | derivative No. 2 | derivative |
| 18 hours later | Transparent | Slightly cloudy, | Slightly cloudy, |
| | solution | Precipitated | Precipitated |

The above results confirmed that the niobium 2-ethylhexanoate derivative of the present invention had excellent solubility in an organic solvent and excellent stability after mixing with other precursor compounds. It was confirmed that the niobium 2-ethylhexanoate derivative of the present invention had an effect of imparting stability to tantalum ethoxide. In contrast, a niobium 2-ethylhexanoate derivative with a large amount of niobium had poor solubility and a niobium 2-ethylhexanoate derivative with a small amount of niobium had poor stability after mixing with other precursor compounds.

This shows the niobium 2-ethylhexanoate derivative of the present invention has specifically excellent effects as a precursor for the MOD method.

### Example 2

The niobium 2-ethylhexanoate derivative No. 1 obtained in Example 1 above and lead 2-ethylhexanoate were dissolved in butanol, thereby preparing an organic acid metal salt composition 1 in which the metal molar ratio of niobium and lead was 1:1 and the metal concentration of a total of niobium and lead was 0.1 mol/l.

### Comparative Example 3

Except for using pentakis(ethoxy)niobium in place of the niobium 2-ethylhexanoate derivative, a comparative organic acid metal salt composition 2 having the same proportion (a metal molar ratio, concentration in terms of metal) as that in Example 2 above was prepared.

Evaluation 3

10 ml of the organic acid metal salt composition 1 of the present invention obtained in Example 2 above and 10 ml of the comparative organic acid metal salt composition 2 obtained in Comparative Example 3 above were placed in a 20-ml sample bottle. The sample was kept in a thermo-hygrostat chamber having a temperature of 30° C. and a humidity of 50% for 18 hours, and then the sample conditions were observed. As a result, the organic acid metal salt composition 1 was transparent, but the organic acid metal salt composition 2 was cloudy, and a precipitate was observed therein.

Evaluation 4

The organic acid metal salt composition 1 of the present invention obtained in Example 2 above and the comparative organic acid metal salt composition 2 obtained in Comparative Example 3 were evaluated for pyrolysis behavior using TG-DTA. The measurement conditions of TG-DTA were as follows: atmosphere: air 300 ml/min; temperature program: measurement range 30° C. to 600° C.; temperature elevation rate 10° C./min; and reference: alumina 7.575 mg. As for the amount of samples, the organic acid metal salt composition 1 was 23.6935 mg and the organic acid metal salt composition 2 was 24.3817 mg.

As a result, the DTA of the organic acid metal salt composition 1 showed one broad exothermic peak whose peak was 291° C., and the DTA of the organic acid metal salt composition 2 showed a broad exothermic peak whose peak was 294° C. and a broad exothermic peak whose peak was 321° C.

Evaluation 3 above confirmed that the organic acid metal salt composition 1 of the present invention had more excellent storage stability than that of the comparative organic acid metal salt composition 2. Moreover, Evaluation 4 showed that the organic acid metal salt composition 1 showed one pyrolysis peak and the organic acid metal salt composition 2 showed two pyrolysis peaks. This shows that, in the organic acid metal salt composition 1, the niobium 2-ethylhexanoate derivative and the lead 2-ethylhexanoate derivative simultaneously pyrolized. In contrast, in the organic acid metal salt composition 2, the niobium precursor and the lead precursor separately decomposed. This suggests that a thin film, which is obtained as a material for the MOD method of producing a composite metal-containing thin film from the organic acid metal salt composition 1, has excellent uniformity in the thin film composition.

### Example 3

The niobium 2-ethylhexanoate derivative No. 1 obtained in Example 1 above, lead 2-ethylhexanoate, tetrakis(isopropoxy)titanium, and tetrakis(butoxy)zirconium were dissolved in butanol, thereby preparing an organic acid metal salt composition 3 in which a metal molar ratio of niobium, lead, titanium, and zirconium was 1:1:0.5:0.5 and a metal concentration of a total of niobium, lead, titanium, and zirconium was 0.1 mol/l.

### Comparative Example 4

Except for using pentakis(ethoxy)niobium in place of the niobium 2-ethylhexanoate derivative, a comparative organic acid metal salt composition 4 having the same proportion (a metal molar ratio, concentration in terms of metal) as that in Example 1 above was prepared.

### Comparative Example 5

Tetrakis(isopropoxy)titanium and tetrakis(butoxy)zirconium were dissolved in butanol, thereby preparing a comparative organic acid metal salt composition 5 in which a metal molar ratio of titanium and zirconium was 1:1 and a metal concentration of a total of titanium and zirconium was 0.05 mol/1.

Evaluation 5

10 ml of the organic acid metal salt composition 3 of the present invention obtained in Example 3 above and 10 ml each of the comparative organic acid metal salt compositions 4 and 5 obtained in Comparative Examples 4 and 5 above were placed in a 20-ml sample bottle. The sample was kept in a temperature and humidity constant chamber having a temperature of 30° C. and a humidity of 50% for 18 hours, and then the sample conditions were observed. As a result, the organic acid metal salt composition 3 was transparent, but the organic acid metal salt compositions 4 and 5 were cloudy, and precipitates were observed therein.

Evaluation Example 5 above confirmed that the organic acid metal salt composition 3 of the present invention had superior storage stability than those of the comparative organic acid metal salt compositions 4 and 5.

### Example 4

A thin film was formed on a 6-inch silicon wafer according to the following procedure using the organic acid metal salt composition 3 obtained in Example 3 above and the organic acid metal salt composition 4 obtained in Comparative Example 4 above. The surface condition of the obtained thin film was visually observed and by using a polarization light microscope (×100). As a result, the thin film obtained from the organic acid metal salt composition 3 was uniform, and no cracks, aggregates, or pinholes were observed. The thin film obtained from the comparative organic acid metal salt composition 4 was partially cloudy, and aggregates and cracks were observed.

(Procedure)

2 ml of the organic acid metal salt composition was cast on a silicon wafer, and the resultant was spin coated at 500 rpm for 5 seconds and at 1500 rpm for 15 seconds. A silicon wafer was heated on a 100° C. hot plate for 30 seconds to dry the solvent, and the resultant was calcined at 300° C. for 2 minutes and returned to room temperature. The spin coating, drying, calcination, and cooling were repeated 3 times, followed by sintering by heating in an electric furnace at 600° C. for 3 minutes.

Example 4 confirmed that a thin film obtained using the organic acid metal salt composition 3 of the present invention had excellent properties that were uniform.

1. A method of forming a thin film on a substrate, comprising:
applying on a substrate an organic acid metal salt composition comprising:
a) a niobium 2-ethylhexanoate derivative having a niobium content of from 13 to 16 mass % and a carbon content within a range of from 50 to 58 mass %,
the niobium 2-ethylhexanoate derivative consisting only of:
niobium atoms;
oxygen atoms; and
2-ethylhexanoic acid residues;
b) a metal precursor other than niobium; and
c) at least one kind of an organic solvent and then
heating the substrate applied with the organic acid metal salt composition to form the thin film including a niobium element and a metal other than niobium.

2. The method according to claim 1, wherein content of the organic solvent in the organic acid metal salt composition is within a range of from 20 to 99 mass %.

3. The method according to claim 1, wherein the metal precursor other than niobium comprises a lead salt compound of an organic acid represented by the general formula (RCOO)₂Pb, where R represents a C₁₋₁₇ aliphatic hydrocarbon group.

4. The method according to claim 3, wherein the lead salt compound of the organic acid comprises lead 2-ethylhexanoate.

5. The method according to claim 3, further comprising lead atoms at a metal molar ratio of 0.01 to 10 mol with respect to one mol of niobium atoms.

6. The method according to claim 1, further comprising another arbitrary metal precursor.

7. The method according to claim 6, wherein the other arbitrary metal precursor comprises at least one kind of a metal alkoxide compound.

8. The method according to claim 7, wherein the metal alkoxide compound is one or more kinds of the compounds selected from the group consisting of titanium alkoxide and zirconium alkoxide.
